(19) United States
(12) Patent Application Publication
(10) Pub. No.: US 2010/0273423 A1
(43) Pub. Date: Oct. 28, 2010

(54) SYSTEM, METHOD AND APPLICATION FOR COORDINATING THE TRANSMISSION OF A GEOLOCATED INSTRUCTION FROM A ROAMING ELEMENT TO AN ONBOARD MULTIMEDIA ELEMENT

(75) Inventor: Jean-Philippe BOYER, Le Chesnay (FR)

Correspondence Address: YOUNG & THOMPSON, 209 Madison Street, Suite 500, Alexandria, VA, 22314, US

(73) Assignees: CONTINENTAL AUTOMOTIVE FRANCE, Toulouse (FR); CONTINENTAL AUTOMOTIVE GmbH, Hannover (DE)

(21) Appl. No.: 12/762,491

(22) Filed: Apr. 19, 2010

(30) Foreign Application Priority Data
Apr. 22, 2009 (FR) 0901928

(51) Int. Cl. H04B 17/00; H04B 7/00

(52) U.S. Cl. 455/41.2; 455/67.14

(57) ABSTRACT

A method, a management system and an application for coordinating the transmission of a geolocated instruction from a roaming element (12) to a multimedia element (4) on board a vehicle. To do this, the method includes notably transmitting an anticipation instruction (24), as a function of a latency time for the restitution of the geolocated instruction by the multimedia element (4) and transmitting this anticipation instruction (24) to the roaming element (12) so as to coordinate the transmission of this geolocated instruction.

The subject of the invention is a management system, a method and an application for coordinating the transmission of a geolocated instruction from a roaming element to a multimedia element on board a vehicle.

The invention relates to the technical field of communication between roaming elements and onboard elements. More particularly, the invention relates to the field of communication between roaming elements fitted with navigation systems and multimedia elements on board motor vehicles. The multimedia elements concerned are, for example, display screens and the audio systems incorporated into the passenger compartment of motor vehicles.

It is known practice in the prior art to install and use portable navigation systems in the passenger compartment of vehicles. These portable navigation systems usually contain onboard intelligence, defining the navigation system as such, capable of determining the position of the system and if necessary the itinerary to be followed to reach a destination. But these portable navigation systems also contain onboard multimedia elements capable of displaying the information items calculated by the onboard intelligence on a display screen and of transmitting audio signals for orally communicating certain geolocated instructions specific to the user of the vehicle.

These portable navigation systems however have certain drawbacks. First of all, their installation in the passenger compartment of the vehicle requires the use of attachment systems that are not very effective and that can lead to the portable navigation system falling. Moreover, the presence of these navigation systems in the passenger compartment of motor vehicles also raises problems of security. More particularly, when these portable navigation systems are attached to the windshield of the motor vehicles, they obstruct the field of vision of the driver and are dangerous for the passengers in the event of an accident by being potential projectiles. Moreover, the quality of the multimedia elements of these portable navigation systems is necessarily limited because the display screen and the audio system have reduced dimensions.

This is why these portable navigation systems are disappearing to the benefit of roaming elements capable of being hosted by the vehicle by operating the multimedia elements of the vehicle in order to broadcast the geolocated instructions transmitted by the roaming element. The roaming element (cellphone, PDA, laptop computer, etc.) is then provided with a navigation system capable of communicating with a central unit on board the vehicle and capable of transmitting the geolocated instructions to the multimedia elements of this vehicle in order to orally or visually retranscribe the geolocated instructions transmitted by the navigation system onto the dashboard, onto the multimedia display of the vehicle and/or via onboard speakers.

However, it has been found that the use of such roaming elements linked with the multimedia element of the vehicles could have drawbacks. Specifically, the time for the restitution of a geolocated instruction from the roaming element by the multimedia elements of the vehicle, also called the restitution latency time, is not known by the navigation system. On the contrary, this restitution latency time is independent of the roaming element and depends more on the features of the vehicle and of the system for communication between this vehicle and the roaming element. It is therefore not possible for the navigation system to coordinate the transmission of the geolocated instructions as a function of this restitution latency time in order to broadcast these geolocated instructions at the right moment.

If the restitution latency time is long, the geolocated instructions are broadcast after the situation that was to be anticipated, which is problematic. For example, the user of a motor vehicle becomes aware of a geolocated instruction according to which he was to take a road to the right after having passed through the intersection to said road.

The object of the present invention is to alleviate the drawbacks of the prior art by proposing a management system, a method and an application making it possible to coordinate the transmission of a geolocated instruction from a roaming element to the multimedia elements on board a vehicle as a function of the restitution latency time. A further object of the invention is to produce a management system and a method that take account both of the quality and the availability of the means for communication between the roaming element and the multimedia elements of the vehicle in order to coordinate the transmission of the geolocated instructions. A further object of the invention is to achieve such coordination independently of the navigation system belonging to the roaming element.

To do this, the present invention proposes to evaluate the latency time for the restitution of a geolocated instruction by calculating the transmission time of a first test instruction from the roaming element and to a management system and the time for the processing of a second test instruction from the management system by the multimedia element.

More precisely, the subject of the invention is a management system for coordinating the transmission of a geolocated instruction from a roaming element to a multimedia element on board a vehicle. The management system comprises a first communication module capable of receiving a first information item from a central unit on board the vehicle relating to an evaluation of a time for the processing of the geolocation instructions by the multimedia element; a second communication module capable of dialoging with the roaming equipment so as to obtain a second information item relating to an evaluation of a time for the transfer of a test instruction from the roaming element to the second communication module; a processing module capable of transmitting an anticipation instruction, as a function of a latency time for the restitution of the geolocation instruction by the multimedia element, calculated based on the first and second information items; and communication means capable of transmitting this anticipation instruction to the roaming element so as to coordinate the transmission of this geolocated instruction.

According to advantageous embodiments:
the first communication module is capable of dialoging with the onboard central unit;
the first communication module is capable of dialoging periodically, and preferably at one-second intervals, with the central unit so as to regularly update the first information item;
the second communication module is capable of dialoging periodically, and preferably at one-second intervals, with the roaming element so as to regularly update the second information item.

Advantageously, the second module is capable of:
transmitting the test instruction to the roaming element;
receiving, in response, this test instruction from the roaming element;
determining the second information item by dividing by a determined coefficient (equal to two for example) the time for the transmission and reception of said test instruction.

According to one embodiment, the second communication module is capable of dialoging with the roaming element by a wire link.

Advantageously, the second and third communication modules are capable of dialoging with the roaming element via radio link, preferably via the Bluetooth® communication protocol.

The invention also relates to a motor vehicle comprising a multimedia element, a module capable of communicating with a roaming element and a management system as defined above.

In addition, the invention relates to an application for coordinating the transmission of a geolocated instruction from a roaming element to a multimedia element on board a vehicle. This application comprises instructions for receiving a test instruction from a communication module on board the vehicle; instructions for transmitting, in return, the test instruction to the communication module; instructions for transmitting an anticipation instruction, determined as a function of a latency time for the restitution of the geolocated instruction by the multimedia element, to the roaming element so as to coordinate the transmission of this geolocated instruction.

Preferably, the application also comprises instructions for receiving a first information item relating to an evaluation of a time for the processing of guidance instructions by the multimedia element; instructions for receiving a second information item relating to the time for the transfer of a test instruction from the roaming element to the second communication module; instructions for transmitting the anticipation instruction before transmitting this anticipation instruction to the roaming element.

The invention also relates to a method for coordinating the transmission of a geolocated instruction from a roaming element to a multimedia element on board a vehicle. This method comprises the reception of a first information item from a central unit on board the vehicle relating to an evaluation of a time for the processing of the geolocated instructions by the multimedia element; the dialog with the roaming element so as to obtain a second information item from the roaming element relating to an evaluation of a time for the transfer of a test instruction from the roaming element to the second communication module; the determination of an anticipation instruction, as a function of the latency time for the restitution of the geolocated instruction calculated based on the first and second information items; and the transmission of this anticipation instruction to the roaming element so as to coordinate the transmission of this geolocated instruction.

The calculation of the first and second information items relating respectively to the time for the processing of the instructions by the multimedia element and the time for the transfer of a test instruction from the roaming element and to the second module makes it possible to evaluate the latency for the restitution of a geolocated instruction and therefore to coordinate the transmission of this geolocated instruction as a function of this evaluated restitution latency time. Moreover, the restitution latency time thus calculated is determined, in a precise manner, as a function of the real state at a given moment of the system in operation.

Producing a management system allowing dialog between the first module and the onboard central unit, on the one hand, and between the second module and the roaming element, on the other hand, makes it possible to regularly repeat a test phase for updating the restitution latency datum as a function of the availability of the communication means. Therefore, when the system is very busy (the radio being used when passing through a tunnel, multimedia files being read etc.), the restitution latency time is long and the geolocated instructions are transmitted by the roaming element in an anticipated manner.

Evaluating the time for transferring a geolocated instruction by dividing by a determined coefficient (equal to two for example) the time necessary to transfer a test instruction from the second module to the roaming element and again to the second module makes it possible to obtain an information item taking account of both the intrinsic and extrinsic characteristics inherent in the means for communication between the roaming element and the multimedia element.

It is understood that “geolocated instruction” extends to any instruction generated by a roaming element and returned through the multimedia element of a vehicle for any application involving the transmission of instructions in multimedia form, the pertinence of which depends on the geolocation of the vehicle at the moment of their generation.

Other features and advantages of the invention will emerge on reading detailed exemplary embodiments, with reference to the appended figures representing respectively:

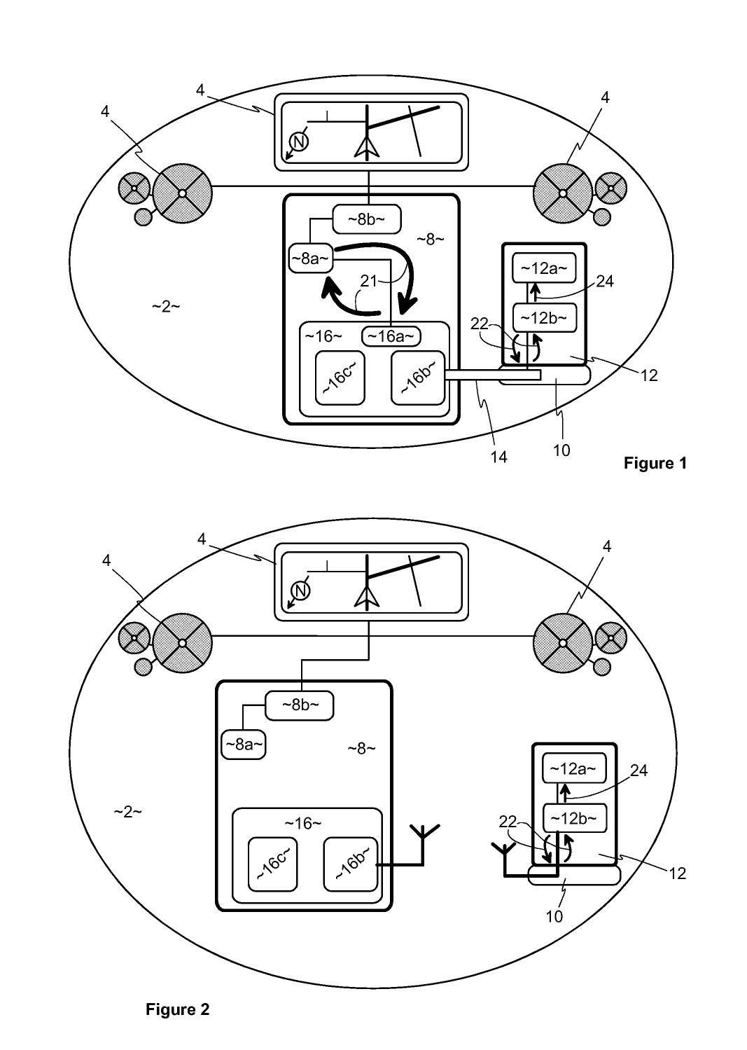

FIG. 1, a schematic representation of a first embodiment of a vehicle comprising a management system according to the invention; and

FIG. 2, a schematic representation of a second embodiment of a vehicle comprising a management system according to the invention.

FIG. 1 represents the passenger compartment of a motor vehicle 2 comprising multimedia elements 4 and a central unit 8 connected to a pedestal 10 for receiving a roaming element 12.

A dashboard furnished with a display screen and an audio system form a portion of the multimedia element 4 of the vehicle 2. They are therefore built into the passenger compartment of this vehicle 2 so as to provide optimum viewing and listening for the users of the vehicle 2. These multimedia elements 4 are connected to the central unit 8 which manages at least a portion of the electronic data of the vehicle 2. The central unit 8 more particularly comprises a process analysis module 8a capable of determining the resources consumed by the central unit 8 for each application, information making it possible a priori to estimate the time for the processing of each of the instructions processed by this central unit 8. This central unit 8 also comprises a module 8b for controlling the multimedia elements 4 making it possible to control respectively the dashboard and the audio system of the vehicle 2. The process analysis module 8a can therefore determine the time for the processing of the instructions by measuring the activity, in particular, of the control module 8b of the multimedia elements.

According to the embodiment shown in FIG. 1, the receiving pedestal 10 belonging to the passenger compartment of the vehicle 2 comprises a connection peripheral device making it possible to receive and interchange useful information items with the roaming element 12. The roaming element 12 comprises, for its part, a GPS navigation module 12a, and an application 12b capable of communicating with the navigation module 12a in order, notably, to coordinate the transmission of the geolocated instructions.

The receiving pedestal 10 is also connected to the central unit 8 via a communication bus 14 optionally connected to other elements of the vehicle 2 (air conditioning system, radio system, telephone system, etc.). The useful information items are from the roaming element 12 is then transmitted, via the communication bus 14, to a management unit 16 advantageously belonging to the central unit 8.

The function of the management unit 16 is to evaluate the time for the restitution of the geolocated instructions by the multimedia elements 4 of the vehicle 2 after they have been transmitted by the roaming element 12. This transfer time depends not only on the intrinsic and extrinsic characteristics of the communication bus 14, but also on the conditions of operation, at a given moment, of the multimedia elements 4 of the vehicle 2. To do this, the management unit 16 comprises a first module 16a for communication with the process analysis module 8a, a second module 16b for communication with the roaming element 12 and a third module 16c for the processing of the information received.

Therefore, when the management unit 16 detects the presence of the roaming element 12, a first request 21 is transmitted from the first module 16a to the process analysis module 8a in order to determine, depending on the conditions of use of the multimedia elements 4, an evaluation of the time for the processing of the geolocated instructions by the multimedia elements. The process analysis module 8a then returns a first datum based on which this evaluation of the time for the processing of the geolocated instructions by the multimedia elements of the vehicle can advantageously be calculated.

Moreover, a test instruction 22 is transmitted from the second module 16b to the application 12b installed in the roaming element 12. The function of this application 12b is to receive the test instruction 22 and to immediately forward it to the second module 16b of the management unit 16. In this manner, a management unit 16 can evaluate the time for the transfer of a geolocated instruction from the roaming element to the management unit 16 by dividing the transit time of the second test instruction 22 by an appropriate coefficient, and advantageously by two. This test instruction 22 can, for example, be executed by a PING command (the acronym for “Packet InterNet Grouper”) which makes it possible to send an “echo” request from one system to another. It is therefore possible to assign to the test instruction characteristics similar to the characteristics of a geolocated instruction.

The management unit 16 then has a first datum 21 relating to the time for the processing of the instructions by the multimedia element 4 and a second datum relating to the time for the transfer of a second test instruction 22 from the roaming element 12 to the management unit 16. The third module 16c then receives these first and second data in order to determine an evaluation of the latency time for the restitution of a geolocated instruction originating from the roaming element 12 and broadcast by the multimedia elements 4. An anticipation instruction 24 determined as a function of this restitution latency time is then transmitted to the application 12b via the communication bus 14. The application 12b then communicates this anticipation instruction 24 to the navigation system 12a so that the transmission of the geolocated instructions is anticipated so as to compensate for the delay due to the restitution latency time.

This process of calculating the restitution latency time can then be carried out regularly at a frequency dependent on the multimedia system 4. For example, the first and second data are advantageously calculated every second in order to reevaluate the anticipation instruction to be communicated to the navigation system 12a of the roaming element 12.

A second embodiment of the invention is shown in FIG. 2 attached.

According to this second embodiment, the management module 16 is independent of the central unit 8 of the vehicle 2 and comprises no first module 16a. Moreover, this management unit 16 communicates with the roaming element via radio link, for example via a Bluetooth® protocol. The operation of the management unit 16 however remains substantially similar to that of the exemplary embodiment of FIG. 1.

Specifically, in this embodiment, the first datum relating to the time for the processing of the instructions by the multimedia element is approximated by a constant, dependent on the vehicle, inserted into the configuration of the third module 16c.

In addition, the module 16b uses as a test instruction 22 the standard instructions inherent in the Bluetooth® communication protocol involving, in a predictive manner, a question—answer mechanism. The system advantageously uses the fact that such instructions are transmitted throughout the service life of the system with a nonzero occurrence from the second module 16b to the roaming element 12 via radio waves and according to a predetermined and public protocol by the Bluetooth® standard. As above, the reception of these instructions inherent to the Bluetooth® protocol by the roaming element 12 generates the transmission of a instruction in return to the multimedia element through the communication module 16b. The measurement of these question—answer times is used by the second module 16b of the management unit 16 to extrapolate a second datum corresponding to an evaluation of the time for the transfer of a geolocated instruction from the roaming element 12 to the management unit 16.

According to this embodiment, the third module 16c then uses these first and second data in order to determine an evaluation of the latency time for the restitution of a geolocated instruction originating from the roaming element 12 and broadcast by the multimedia elements 4. An anticipation instruction 24 determined as a function of this restitution latency time is then transmitted to the application 12b via the radio waves of the Bluetooth® standard. The application 12b then communicates this anticipation instruction 24 to the navigation system 12a so that the transmission of the geolocated instructions is anticipated so as to compensate for the delay due to the restitution latency time.

This restitution latency time calculation process can be, as above, carried out continuously. However, according to a particular embodiment, the calculation process is generated only once during the initiation of the connection between the roaming element 12 and the management module 16 and is not subsequently repeated.

According to a third embodiment, the management module 16 contains no third module 16c. The operation of the management unit 16 however remains substantially similar to one or other of the examples described above.

Specifically, the first and second data are directly transmitted from the management unit 16 to the onboard application 12b. This application 12b undertakes to calculate, based on these first and second information items, the latency time for the restitution of a guidance instruction originating from the roaming element 12 and broadcast by the multimedia elements 4. An anticipation instruction 24 determined as a function of this restitution latency time is then transmitted from the application 12b to the navigation system 12a so that the transmission of the guidance instructions is anticipated in order to compensate for the delay due to the restitution latency time.

The invention is not limited to the embodiments described and shown. It is also possible to provide any modification that forms part of the general knowledge of those skilled in the art.

1. A management system for coordinating the transmission of a geolocated instruction from a roaming element (12) to a multimedia element (4) on board a vehicle, characterized in that it comprises:
a first communication module (16a) capable of receiving a first information item (21) from a central unit (8) on board the vehicle relating to an evaluation of a time for processing geolocated instructions by the multimedia element (4);
a second communication module (16b) capable of dialoging with the roaming element (12) so as to obtain a second information item relating to an evaluation of a time for transferring a test instruction (22) from the roaming element (12) to the second communication module (16b);
a processing module (16c, 12b) capable of transmitting an anticipation instruction (24) as a function of a latency time for the restitution of the geolocated instruction by the multimedia element (4), calculated based on the first and second information items; and
communication means (16b, 12b) capable of transmitting this anticipation instruction (24) to the roaming element (12) so as to coordinate the transmission of this geolocated instruction.

2. The management system as claimed in claim 1, wherein the first communication module (16a) is capable of dialoging periodically, preferably at one-second intervals, with the central unit (8) so as to regularly update the first information item.

3. The management system as claimed in claim 1, wherein the second communication module (16b) is capable of dialoging periodically, and preferably at one-second intervals, with the roaming element (12) so as to regularly update the second information item.

4. The management system as claimed in claim 1, wherein the second module is capable of:
transmitting the test instruction (22) to the roaming element (12);
receiving, in response, this test instruction (22) from the roaming element (12);
determining the second information item by dividing the time for the transmission and reception of said test instruction (22) by a predetermined coefficient.

5. The management system as claimed in claim 1, wherein the second communication module (16b) is capable of dialoging with the roaming element (12) via a wire link.

6. The management system as claimed in claim 1, wherein the second and third communication modules (16b) are capable of dialoging with the roaming element (12) via a radio link, preferably via the Bluetooth® communication protocol.

7. A motor vehicle comprising a multimedia element (4) and a module capable of communicating with a roaming element (12), characterized in that it comprises a management system as claimed in claim 1.

8. An application for coordinating the transmission of a geolocated instruction from a roaming element (12) to a multimedia element (4) on board a vehicle (2), characterized in that it comprises:
instructions for receiving a first information item (21) relating to an evaluation of a time for the processing of guidance instructions by the multimedia element (4);
instructions for receiving a second information item relating to the time for transferring a test instruction (22) from the roaming element (12) to the second communication module (16b);
instructions for transmitting an anticipation instruction (24), determined as a function of a latency time for the restitution of the geolocated instruction by the multimedia element (4), to the roaming element (12) so as to coordinate the transmission of this geolocated instruction.

9. A method for coordinating the transmission of a geolocated instruction from a roaming element (12) to a multimedia element (4) on board a vehicle (2), characterized in that it consists in performing tasks comprising:
the reception of a first information item from a central unit (8) on board the vehicle (2) relating to an evaluation of a time for the processing of geolocated instructions by the multimedia element (4);
the dialog with the roaming element (12) so as to obtain a second information item from the roaming element (12) relating to an evaluation of a time for the transfer of a test instruction (22) from the roaming element (12) to the second communication module (16b);
the determination of an anticipation instruction (24), as a function of the latency time for the restitution of the geolocated instruction, calculated based on the first and second information items; and
the transmission of this anticipation instruction (24) to the roaming element (12) so as to coordinate the transmission of this geolocated instruction.

10. The management system as claimed in claim 2, wherein the second module is capable of:
transmitting the test instruction (22) to the roaming element (12);
receiving, in response, this test instruction (22) from the roaming element (12);
determining the second information item by dividing the time for the transmission and reception of said test instruction (22) by a predetermined coefficient.

11. The management system as claimed in claim 2, wherein the second communication module (16b) is capable of dialoging with the roaming element (12) via a wire link.

12. The management system as claimed in claim 2, wherein the second and third communication modules (16b) are capable of dialoging with the roaming element (12) via a radio link, preferably via the Bluetooth® communication protocol.

13. The management system as claimed in claim 3, wherein the second module is capable of:
transmitting the test instruction (22) to the roaming element (12);
receiving, in response, this test instruction (22) from the roaming element (12);
determining the second information item by dividing the time for the transmission and reception of said test instruction (22) by a predetermined coefficient.

14. The management system as claimed in claim 3, wherein the second communication module (16b) is capable of dialoging with the roaming element (12) via a wire link.

15. The management system as claimed in claim 3, wherein the second and third communication modules (16b) are capable of dialoging with the roaming element (12) via a radio link, preferably via the Bluetooth® communication protocol.

16. The management system as claimed in claim 4, wherein the second communication module (16b) is capable of dialoging with the roaming element (12) via a wire link.

17. The management system as claimed in claim 4, wherein the second and third communication modules (16b) are capable of dialoging with the roaming element (12) via a radio link, preferably via the Bluetooth® communication protocol.
